(19) United States
(12) Patent Application Publication
(10) Pub. No.: US 2008/0215419 A1
(43) Pub. Date: Sep. 4, 2008

(54) METHOD, SYSTEM, AND STORAGE MEDIUM FOR IMPLEMENTING A MULTI-STAGE, MULTI-CLASSIFICATION SALES OPPORTUNITY MODELING SYSTEM

(75) Inventors: Jamshid A. Vayghan, North Oaks, MN (US); Philip S. Yu, Chappaqua, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/120,475

(22) Filed: May 14, 2008

Related U.S. Application Data
(63) Continuation of application No. 10/988,666, filed on Nov. 15, 2004.

(51) Int. Cl. G06Q 10/00

(52) U.S. Cl. 705/10

(57) ABSTRACT

A method for implementing a multi-stage, multi-classification sales opportunity modeling system. The method includes receiving operational data relating to past sales activities and receiving parameters identified as being relevant in determining a likelihood of whether exploitation of a sales opportunity will be successful. The method also includes generating a multi-stage model by applying the operational data and the parameters to an analytic engine for evaluating different factors affecting success of the sales opportunity.

### CROSS-REFERENCE TO RELATED APPLICATION

This application is a continuation of U.S. patent application Ser. No. 10/988,666, filed Nov. 15, 2004, the disclosure of which is incorporated by reference herein in its entirety.

### BACKGROUND

Embodiments of the invention relate generally to data modeling activities, and more particularly, to a method, system, and storage medium for implementing a multi-stage, multi-classification sales opportunity modeling system.

In any sales business, an enterprise typically evaluates opportunity data in order to forecast demands for its offerings. The forecasts may be used to predict the enterprise's future financial performance and the enterprise may develop business plans to achieve their financial goals. Usually, the evaluation of sales opportunities is performed manually by human experts without significant assistance from decision-aid tools. Human error, shortage of skills, and evaluation costs are major concerns with existing evaluation processes. Moreover, a financial and business plan that is based upon inaccurate or inadequate forecasts may cause irreparable harm to the business.

What is needed, therefore, is a sales opportunity evaluation process that provides an enterprise with confidence that there will be a substantial likelihood of success should the opportunity be exploited.

### SUMMARY

Exemplary embodiments relate to a method, system, and storage medium for implementing a multi-stage, multi-classification sales opportunity modeling system. The method includes receiving operational data relating to past sales activities and receiving parameters identified as being relevant in determining a likelihood of whether exploitation of a sales opportunity will be successful. The method also includes generating a multi-stage model by applying the operational data and the parameters to an analytic engine for evaluating different factors affecting success of the sales opportunity.

The system for implementing the multi-stage, multi-classification sales opportunity modeling system includes a processor executing a sales opportunity modeling application and a storage device housing operational data relating to past sales activities. The sales opportunity modeling application receives parameters identified as being relevant in determining a likelihood of whether exploitation of a sales opportunity will be successful. The sales opportunity modeling application also generates a multi-stage model by applying the operational data and the parameters to an analytic engine for evaluating the different factors affecting success of the sales opportunity.

The storage medium is encoded with machine-readable program code for implementing a multi-stage, multi-classification sales opportunity modeling system. The program code includes instructions for causing a processor to implement a method. The method includes receiving operational data relating to past sales activities and receiving parameters identified as being relevant in determining a likelihood of whether exploitation of a sales opportunity will be successful. The method also includes generating a multi-stage model by applying the operational data and the parameters to an analytic engine for evaluating the different factors affecting success of the sales opportunity.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a block diagram of a system upon which the sales opportunity modeling system may be implemented in exemplary embodiments;

FIG. 2 is a flow diagram illustrating a process for generating a multi-stage model in exemplary embodiments;

FIG. 3 is a user interface screen depicting a sample menu of options selectable via the sales opportunity modeling system in exemplary embodiments;

FIG. 4 is a multi-stage model generated by the sales opportunity modeling system for use in evaluating a potential sales opportunity in exemplary embodiments;

FIGS. 5A and 5B are flowcharts illustrating how the process software implementing the systems and methods of the invention may be integrated into client, server, and network environments;

FIGS. 6A and 6B are flowcharts illustrating various ways in which the process software of the invention may be semi-automatically or automatically deployed across various networks and onto server, client (user), and proxy computers;

FIGS. 7A through 7C are flowcharts illustrating how process software for implementing the systems and methods of the invention are deployed through the installation and use of two different forms of a virtual private network (VPN); and

FIGS. 8A and 8B are flowcharts illustrating how the process software for implementing the systems and methods of the invention can be deployed through an On Demand business model, which allows the process software to be shared and simultaneously service multiple customers in a flexible, automated fashion under a pay-for-what-you-use plan.

### DETAILED DESCRIPTION OF EXEMPLARY EMBODIMENTS

In accordance with exemplary embodiments, a method, system, and storage medium for implementing a multi-stage, multi-classification sales opportunity modeling system is provided. The sales opportunity modeling system of the invention includes a sales opportunity evaluation process that provides an enterprise with confidence that there will be a substantial likelihood of success should the opportunity be exploited. The sales opportunity modeling system breaks down the sales opportunity evaluation into multiple stages: detection, verification, and justification. Upon successful completion of the first stage, the evaluation process continues to the second. If at any time, the evaluation process returns undesirable results, the process is either aborted without proceeding to the next stage, or the evaluation criteria is altered and the data is reprocessed. The sales opportunity modeling system further enables an evaluator to review the results at each stage. The result include multi-classification result information including whether the sales opportunity is expected to be successful, unsuccessful (a failure), and if unsuccessful, the reasons therefore.

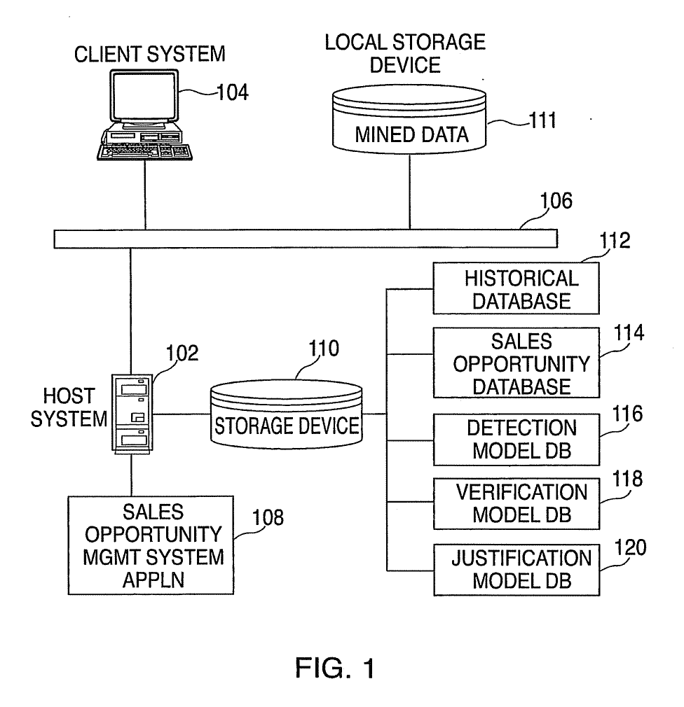

Turning now to FIG. 1, a block diagram of a system upon which the sales opportunity modeling system may be implemented in exemplary embodiments will now be described. The system of FIG. 1 includes a host system 102 in communication with a client system 104 via a network 106. Host system 102 may be implemented using one or more high-speed processors (e.g., servers) operating in response to a computer program stored in a storage medium accessible by the server(s). The host system 102 may operate as a network server (e.g., a web server) to communicate with client system 104. The host system 102 may handle sending and receiving information to and from client system 104 and may perform associated tasks.

The host system 102 may also operate as an application server. The host system 102 executes one or more computer programs to implement sales opportunity modeling system activities. These one or more computer programs are referred to collectively herein as a sales opportunity modeling system application 108. In exemplary embodiments, sales opportunity modeling system application 108 includes a data mining component, feature subset selection component, and analytic engine. Alternatively, the data mining component, feature subset selection component, and analytic engine may be implemented independently of the sales opportunity modeling system application 108. Processing of sales opportunity modeling system activities may be shared by the client system 104 and the host system 102 by providing an application (e.g., java applet) to the client system 104. Alternatively, client system 104 may include stand-alone software applications for performing a portion or all of the processing described herein. As previously described, it is understood that separate servers may be utilized to implement the network server functions and the application server functions. Alternatively, the network server and the application server may be implemented by a single server executing computer programs to perform the requisite functions.

Client system 104 may be coupled to host system 102 via network 106. Further, client system 104 may be implemented using a general-purpose computer executing a computer program for carrying out some of the processes described herein. The client system 104 may be a personal computer (e.g., a lap top, a personal digital assistant) or host attached terminals. If client system 104 is a personal computer, the processing described herein may be shared by client system 104 and host system 102 (e.g., by providing an applet to client system 104). For purposes of illustration, client system 104 is operated by a product development engineer or specialist.

Network 106 may be any type of known network including, but not limited to, a wide area network (WAN), a local area network (LAN), a global network (e.g. Internet), a virtual private network (VPN), and an intranet. The network 106 may be implemented using a wireless network or any kind of physical network implementation known in the art. Client system 104 may be coupled to the host system 102 through multiple networks (e.g., intranet and Internet) so that not all client systems are coupled to the host system 102 through the same network. One or more of the client systems and the host system 102 may be connected to the network 106 in a wireless fashion. In one embodiment, the network is an intranet and one or more client systems execute a user interface application (e.g. a web browser) to contact the host system 102 through the network 106 while another client system may be directly connected to the host system 102.

In exemplary embodiments, the sales opportunity modeling system shown in FIG. 1 includes storage devices 110 and 111. Storage devices 110-111 are in communication with host system 102 and may be implemented using a variety of devices for storing electronic information. It is understood that the storage devices 110-111 may be implemented using memory contained in the host system 102 or may be separate physical devices. The storage devices 110-111 are logically addressable as consolidated data sources across a distributed environment that includes network 106. Information stored in the storage devices 110-111 may be retrieved and manipulated via the host system 102. The storage devices 110-111 house one or more databases of information. In an exemplary embodiment, the host system 102 operates as a database server and coordinates access to application data including data stored on storage devices 110-111.

In accordance with exemplary embodiments, databases in storage device 110 include an historical database 112 and sales opportunity database 114. Historical database 112 may house operational data of a business enterprise executing the sales opportunity modeling system application 108. Operational data may include sales information such as orders for goods and/or services placed by customers, orders satisfied by the enterprise, canceled orders, orders placed but not satisfied by the enterprise, etc. This information is typically in the form of invoices, receipts, shipping documents, and similar types of records. Supplemental information may also be stored in historical database 112 that relates to the above-described sales data. For example, logistical issues that prevented sales orders from being satisfied (e.g., inadequate resources, supplier deficiencies, defects in manufacturing processes, and economic or regulatory issues. Likewise, information that provides reasons for which customers have canceled orders may be stored in historical database 112 (e.g., product recall announcements, a competitor's product that is new to the market, inadequate marketing efforts, etc.). It will be appreciated that a variety of additional information may also be stored in historical database 112 as desired by the enterprise.

Sales opportunity database 114 may store information obtained by the enterprise regarding customer demand or needs. Marketing, research and development (R&D), and/or sales groups typically scope out customer needs and wants through responses to surveys and various methods of research in order to identify opportunities for developing new and enhanced products and services. This type of information is stored in sales opportunity database 114.

Also stored in storage device 110 are detection stage model database 116, verification stage model database 118, and justification stage model database 120. Each multi-stage model includes three stage models and is formulated via the execution of sales opportunity modeling system application 108 using data obtained from historical database 112, which in turn, produces a detection stage model, verification stage model, and justification stage model. Sales opportunity data in database 114 is then applied to the model in order to evaluate potential sales opportunities as described further herein.

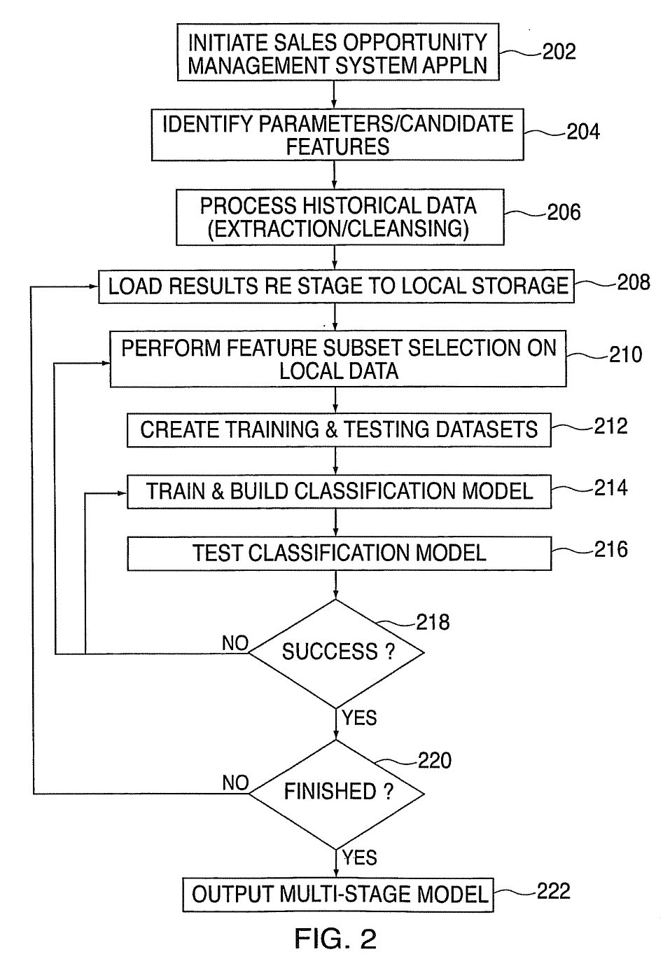

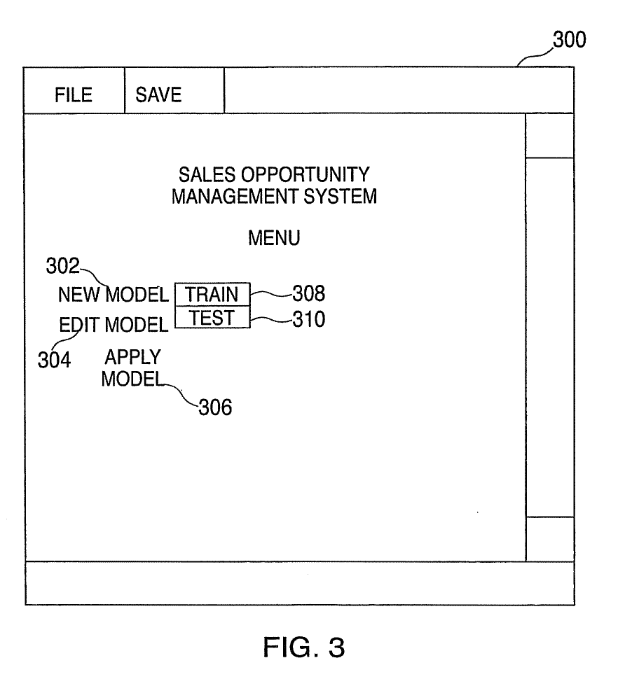

Turning now to FIG. 2, a flow diagram illustrating a process for generating a multi-stage model in exemplary embodiments will now be described. The process begins at step 202 whereby a user of client system 104 accesses the sales opportunity modeling system application 108. A user interface screen is presented to the user with a main menu, a sample of which is shown in FIG. 3. The user interface screen 300 of FIG. 3 depicts a sample menu of options selectable by a user of the sales opportunity modeling system application 108: NEW MODEL 302, EDIT MODEL 304, and APPLY MODEL 306. The user selects NEW MODEL 302 for generating a new multi-stage model.

The sales opportunity modeling system application 108 prompts the user to enter desired parameters or candidate features that are considered relevant in predicting the success and failure for a sales opportunity. For example, a time period may be relevant in determining the success of an opportunity (e.g., Christmas season for children's toys). The sales opportunity modeling system application 108 performs data extraction and cleansing on the data in historical database 112 at step 206. This step includes filtering the documents (e.g., receipts, invoices, etc.) and collecting the relevant data from these documents (e.g., product name, number of orders, pricing and payment information, etc.). It will be understood that step 206 may be performed well in advance of generating the stage model(s) described in FIG. 2, particularly where the historical data is voluminous and the processing time consuming.

The filtered data is then loaded into local storage device 111 in accordance with the specific modeling stage being addressed at step 208. The first stage to be modeled is the detection stage. Accordingly, in exemplary embodiments, only the filtered data relevant to the detection stage is loaded into local storage device 111.

Utilizing the parameters selected by the user in step 204, the loaded data is processed using, e.g., a feature subset selection process at step 210. The feature subset selection process identifies which of the loaded data are applicable to the parameters selected by the user. The processes executed by the feature subset selection process are well known in the data mining community and will be understood by those skilled in the art.

The sales opportunity modeling system application 108 creates training and testing datasets using filtered data from historical database 112 at step 212. The training and testing datasets may be automatically provided by the sales opportunity management system application 108 or a user may enter specific data via the TRAIN option 308 and/or TEST option 310, respectively, of user interface screen 300 of FIG. 3. At step 214, a stage model is created and an analytical engine applies the training dataset to the model using values that are believed will ensure optimal results. The first stage model created during the process steps described in FIG, 2 is a detection model. The sales opportunity modeling system application 108 then tests the stage model using the testing dataset, which includes variant data that will test the accuracy of the stage model against any aberrational conditions at step 216. If the testing produces undesirable results at step 218, the process returns to step 214 in which the user may evaluate the circumstances causing the unfavorable test results and modify the model if it is determined that the model itself is flawed.

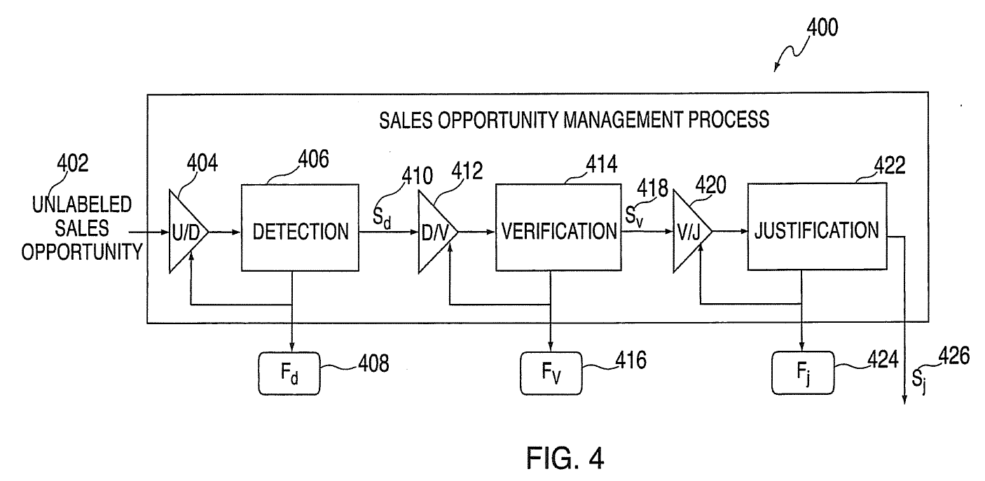

If the testing produces favorable results at step 218, it is determined whether all three stages have been modeled at step 220. As described above, since the detection phase only has been modeled, the process returns to step 208 whereby the sales opportunity modeling system application 108 loads the filtered data that applies to the verification stage into local storage device 111 and the process described in steps 210-220 are repeated until each stage (i.e., detection, verification, and justification) has been modeled. Once all stages have been successfully modeled at step 220, the sales opportunity modeling system application 108 generates a final multi-stage model, a sample of which is shown and described in FIG. 4.

Turning now to FIG. 4, an exemplary multi-stage model generated by the sales opportunity management system for use in evaluating a potential sales opportunity is shown. As described above in FIG. 2, a multi-stage model is formulated based upon historical sales data and user-selected parameters. The multi-stage model is tested to ensure that sales opportunities may be efficiently and accurately evaluated. Once the multi-stage model has been generated, a user may examine a potential sales opportunity via the multi-stage model as described herein.

It is assumed for purposes of illustration, that a user has accessed the sales opportunity modeling system application 108 and selected APPLY MODEL option 306 from user interface screen 300 of FIG. 3. The user is then prompted to provide information relating to a potential sales opportunity 402. This information may be selected from sales opportunity database 114 or may be manually entered by the user. The sales opportunity modeling system application 108 receives the information and removes any data that may be considered unusual or atypical (e.g., if data present in the sales opportunity information 402 does not match any data previously gathered and filtered from historical database 112, it may be eliminated from the modeling process.

The sales opportunity modeling system application 108 then inputs the remaining sales opportunity information to the detection stage model 406. The detection stage model 406 has been trained (via the process described in FIG. 2) to evaluate the veracity and/or accuracy of the sales opportunity information 402. The detection stage model 406 has also been built and tested to provide multi-classification results of the information processed within the model 406. The multi-classification results include: success, failure, and if a failure, the reasons for the failure. The reasons may be gleaned from the processing of documents stored in historical database 112 (e.g., customer reasons for canceling an order). Upon completion of the detection stage model processing, the results may indicate that the sales opportunity is undesirable (reflected in the model 400 as F_{d} 408), along with the reason(s) therefore. The user may evaluate the reasons for the failure and either abort the sales opportunity (i.e., the processing does not continue to the next stage model) or may modify the sales opportunity information and return it to the detection phase for reprocessing.

If the result of the detection stage model indicates that a sales opportunity is likely to be successful (as reflected in FIG. 4 as S_{d}), the sales opportunity information is then aggregated with the results of the detection stage model 412 and input to the verification stage model 414. The verification stage model 414 evaluates the sales opportunity to determine whether the enterprise possesses accurate resources, technology, and expertise to successfully implement the sales opportunity.

As with the detection stage model 406, the verification stage model 414 also provides multi-classification output of its results (shown as Sᵥ 418 for successful results, and Fᵥ 416 for failure results and reasons therefore). The reasons may be gleaned from the processing of documents stored in historical database 112 Upon completion of the verification stage model processing, the results may indicate that the sales opportunity is undesirable along with the reason(s) therefore. The user may evaluate the reasons for the failure and either abort the sales opportunity (i.e., the processing does not continue to the next stage model) or may modify the sales opportunity information and return it to the verification phase for reprocessing.

If the result of the verification stage model 414 indicates that a sales opportunity is likely to be successful (as reflected in FIG. 4 as Sᵥ), the sales opportunity information is then aggregated with the results of the verification stage model 414 and input to the justification stage model 422. The justification stage model 422 evaluates the sales opportunity to determine whether exploiting the sales opportunity is cost-effective and/or worth producing by the enterprise.

As with the detection and verification stage models 406 and 414, the verification stage model 422 also provides multi-classification output of its results (shown as Sⱼ 426 for successful results, and Fⱼ 424 for failure results and reasons therefore). The reasons may be gleaned from the processing of documents stored in historical database 112. Upon completion of the justification stage model processing, the results may indicate that the sales opportunity is undesirable along with the reason(s) therefore. The user may evaluate the reasons for the failure and either abort the sales opportunity (i.e., the processing does not continue to the next stage model) or may modify the sales opportunity information and return it to the justification for reprocessing. If the results indicate that the sales opportunity is desirable, the enterprise moves forward with plans to exploit the opportunity.

The sales opportunity modeling system of the present invention may reside on a stand-alone computer system which may have access to the Internet, or may reside on a computer system which is part of the network through which there is Internet access. With a connection to a network and/or the Internet, there are several different ways in which the process software used to implement the systems and methods of the present invention may be integrated with the network, and deployed using a local network, a remote network, an e-mail system, and/or a virtual private network. The following descriptions review the various ways of accomplishing these activities.

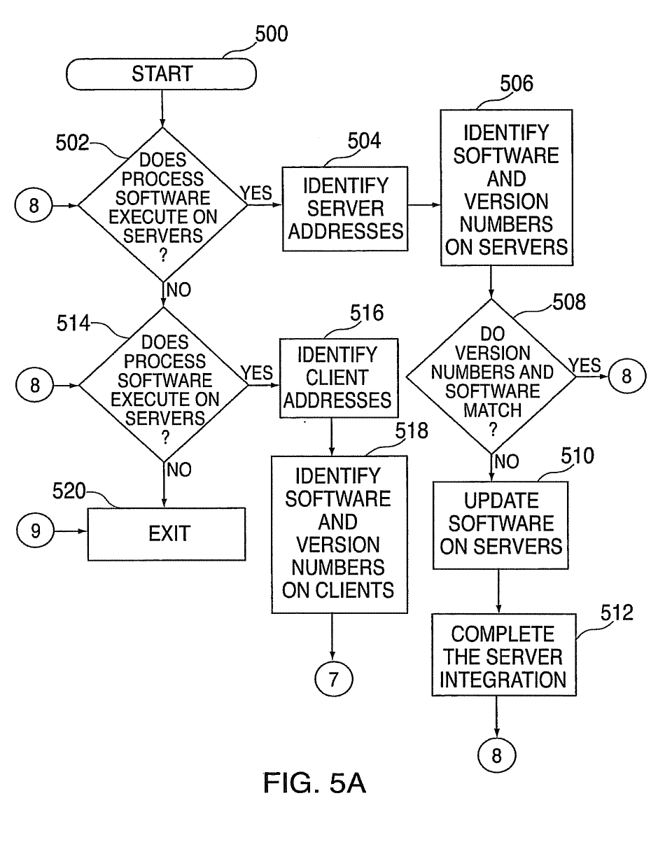

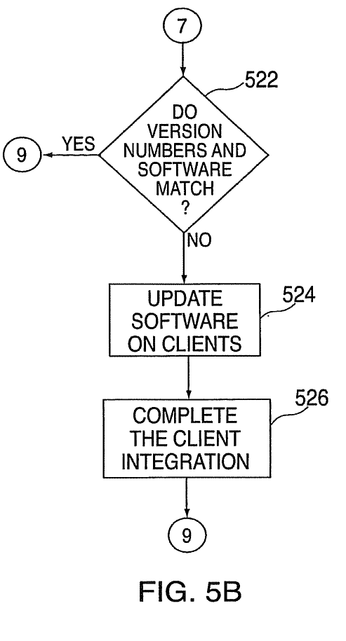

Integration of Sales Opportunity Modeling System Software. To implement the sales opportunity modeling systems and methods of the present invention, process software, which is composed of the software as described above and related components including any needed data structures, is written and then if desired, integrated into a client, server, and network environment. This integration is accomplished by taking those steps needed to enable the process software to coexist with other application, operating system and network operating system software and then installing the process software on the clients and servers in the environment where the process software will function. An overview of this integration activity will now be provided, followed by a more detailed description of the same with reference to the flowcharts of FIGS. 5A and 5B.

The first step in the integration activity is to identify any software on the clients and servers where the process software will be deployed that are required by the process software or that need to work in conjunction with the process software. This includes the network operating system, which is the software that enhances a basic operating system by adding networking features.

Next, the software applications and version numbers are identified and compared to the list of software applications and version numbers that have been tested to work with the process software. Those software applications that are missing or that do not match the correct version are upgraded with the correct version numbers. Program instructions that pass parameters from the process software to the software applications will be checked to ensure the parameter lists match the parameter lists required by the process software. Conversely, parameters passed by the software applications to the process software will be checked to ensure the parameters match the parameters required by the process software. The client and server operating systems including the network operating systems are identified and compared to the list of operating systems, version numbers, and network software that have been tested to work with the process software. Those operating systems, version numbers, and network software that do not match the list of tested operating systems and version numbers are then upgraded on the clients and servers to the required level.

After ensuring that the software resident on the computer systems where the process software is to be deployed is at the correct version level(s), that is, has been tested to work with the process software, the integration is completed. This is done by installing the process software on the clients and servers. Armed with the foregoing overview of the integration activity, the following detailed description of the same should be readily understood.

Referring to FIGS. 5A and 5B, step 500 begins the integration of the process software for implementing the search and reference systems and methods of the present invention. It is determined whether there are any process software programs that will execute on a server or servers at step 502. If this is not the case, then integration proceeds to determine if the process software will execute on clients at step 514. If there are process software programs that will execute on a server(s), then the server addresses are identified at step 504. The servers are checked to see if they contain software that includes the operating system (OS), applications, and network operating systems (NOS), together with their version numbers, that have been tested with the process software at step 506. The servers are also checked to determine if there is any missing software that is required by the process software as part of the activity at step 506. A determination is made whether the version numbers match the version numbers of OS, applications and NOS that have been tested with the process software at step 508. If all of the versions match, and there is no missing required software, the integration continues at step 514. If one or more of the version numbers do not match, then the unmatched versions are updated on the server or servers with the correct versions at step 510. Additionally, if there is missing required software, then it is updated on the server or servers at step 510. The server integration is completed by installing the process software at step 512.

Step 514, which follows either step 502, 508 or 512, determines if there are any programs of the process software that will execute on the clients. If no process software programs execute on the clients, the integration proceeds to step 520 and exits. If there are process software programs that will execute on clients, the client addresses are identified at step 516.

At step 518, the clients are checked to see if they contain software that includes the operating system (OS), applications, and network operating systems (NOS) software, together with their version numbers, that have been tested with the process software. The clients are also checked at step 518 to determine if there is any missing software that is required by the process software.

At step 522, a determination is made if the version numbers match the version numbers of OS, applications and NOS that have been tested with the process software. If all of the versions match, and there is no missing required software, then the integration proceeds to step 520 and exits.

If one or more of the version numbers do not match, then the unmatched versions are updated on the clients with the correct versions at step 524. In addition, if there is missing required software, then it is updated on the clients as part of step 524. The client integration is completed by installing the process software on the clients at step 526. The integration proceeds to step 520 and exits.

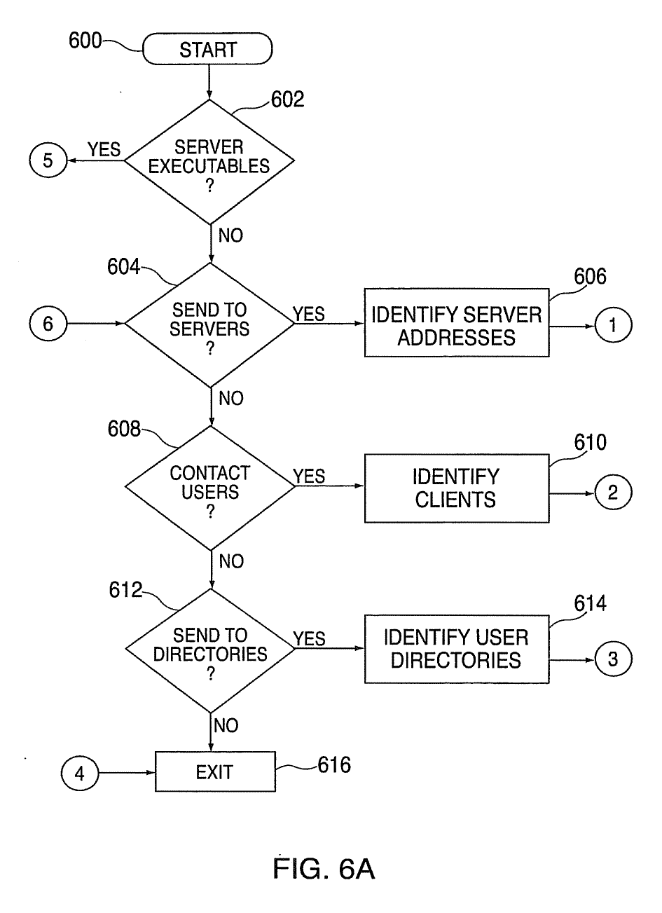

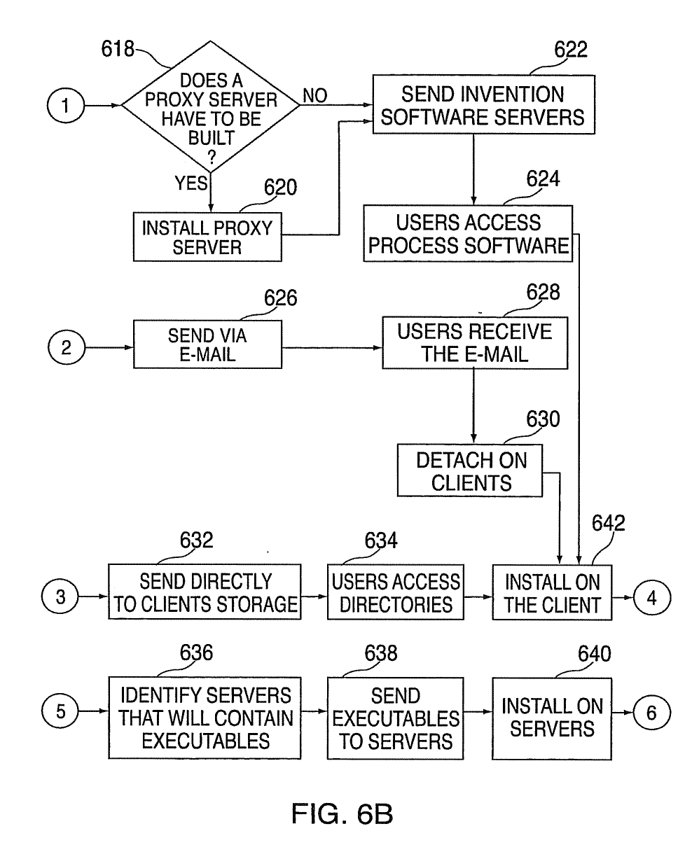

Deployment of Sales Opportunity Modeling System Software. It should be well understood that the process software for implementing the sales opportunity modeling system of the present invention may be deployed by manually loading the process software directly into the client, server, and proxy computers from a suitable storage medium such as a CD, DVD, etc.. It is useful to provide an overview of still other ways in which the process software may also be automatically or semi-automatically deployed into one or more computer systems. The process software may be deployed by sending or loading the process software to a central server or a group of central servers. From there, the process software may then be downloaded into the client computers that will execute the process software. Alternatively, the process software may be sent directly to the client system via e-mail. The process software is then either detached to a directory or loaded into a directory by a button on the e-mail that executes a program that detaches the process software attached to the e-mail into a directory. Another alternative is to send the process software directly to a directory on the hard drive of a client computer. Also, when there are proxy servers, the automatic or self-automatic deployment process will select the proxy server code, determine on which computers to place the proxy servers' code, transmit the proxy server code, and then install the proxy server code on the proxy computer. The process software will be transmitted to the proxy server and then stored on the proxy server. Armed with this overview of the possible deployment processes, the following detailed description of the same with reference to FIGS. 6A and 6B, where the deployment processes are illustrated, will be more easily understood.

Step 600 begins the deployment of the process software. It is determined whether there are any programs that will reside on a server or servers when the process software is executed at step 602. If the answer is “yes”, then the servers that will contain the executables are identified, as indicated in step 636 in FIG. 6B. The process software for the server or servers is transferred directly to the servers' storage via FTP or some other protocol or by copying though the use of a shared file system at step 638. The process software is then installed on the servers as indicated at step 640.

Next, as shown in step 604 in FIG. 6A, a determination is made on whether the process software is to be deployed by having users access the process software on a server or servers. If the users are to access the process software on servers, then the server addresses that will store the process software are identified at step 606.

Next, as shown at step 618, a determination is made if a proxy server is to be built to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed as indicated at step 620. Next, the process software for implementing the present invention is sent to the servers, as indicated in step 622 either via a protocol such as FTP or it is copied directly from the source files to the server files via file sharing. Another way of sending the process software to the servers is to send a transaction to the servers that contained the process software and have the server process the transaction. In this manner, the process software may be received by and copied into the server's file system. Once the process software is stored at the servers, the users via their client computers, then access the process software on the servers and copy it into to the file systems of their client computers at step 624. Another alternative is to have the servers automatically copy the process software to each client and then run the installation program for the process software at each client computer. Either way, the user computer executes or causes to be executed the program that installs the process software on the client computer at step 642, then the process exits at step 616.

Continuing now at step 608 in FIG. 6A, a determination is made as to whether the process software is to be deployed by sending the process software to users via e-mail. If the answer is yes, then, as indicated at step 610, the set of users where the process software will be deployed are identified together with the addresses of the user client computers. The process software is sent via e-mail in step 626 (shown in FIG. 6B) to each of the users' client computers. Then, as indicated in step 628, the users receive the e-mail, and then detach the process software from the e-mail to a directory on their client computers at step 630. The user then executes the program that installs the process software on his client computer at step 642, and then exits the process at step 616.

Continuing at step 612 (see bottom of FIG. 6A), a determination is made on whether the process software will be sent directly to user directories on their client computers. If so, the user directories are identified at step 614. Then, the process software is transferred directly to the identified directory on the user's client computer, as indicated in step 632. This can be done in several ways such as, but not limited to, sharing of the file system directories and then copying them from the sender's file system to the recipient user's file system or, alternatively, using a transfer protocol such as File Transfer Protocol (FTP). Next, the users access the directories on their client file systems, as indicated in step 634, in preparation for installing the process software. Finally, the user executes the program that installs the process software on his client computer at step 642 and then exits the process at step 616.

Use of Virtual Private Networks for Sales Opportunity Modeling System Software. The process software may be deployed, accessed and executed through the use of a virtual private network (VPN). A VPN is any combination of technologies that can be used to secure a connection through an otherwise unsecured or untrusted network. VPNs are used to improve security and can often also reduce operational costs. The VPN makes use of a public network, usually the Internet, to connect remote sites or users together. Instead of using a dedicated, real-world connection such as a leased line, the VPN uses “virtual” connections routed through the Internet from the company's private network to the remote site or employee(s). Access to the software via a VPN can be provided as a service by specifically constructing the VPN for purposes of delivery or execution of the process software (i.e., the software resides elsewhere). In such an instance, the lifetime of the VPN is often limited to a given period of time or to a given number of deployments based on an amount paid.

The process software may be deployed, accessed, and executed through either a remote-access VPN or a site-to-site VPN. When using a remote-access VPN, the process software is typically deployed, accessed, and executed via the secure, encrypted connections between a company's private network and remote users through a third-party service provider. The enterprise service provider (ESP) sets up and/or authorizes access to a network access server (NAS) and provides the remote users with desktop client software for their computers. The telecommuters can then dial a phone number (often a toll-free number) or attach directly via a cable, DSL, or wireless modem to reach the NAS and use their VPN client software to access the corporate network and to access, download, and execute the process software.

When using a site-to-site VPN, the process software is typically deployed, accessed and executed through the use of dedicated equipment and large-scale encryption. These tools are often used to connect multiple fixed sites of a larger company over a public network such as the Internet.

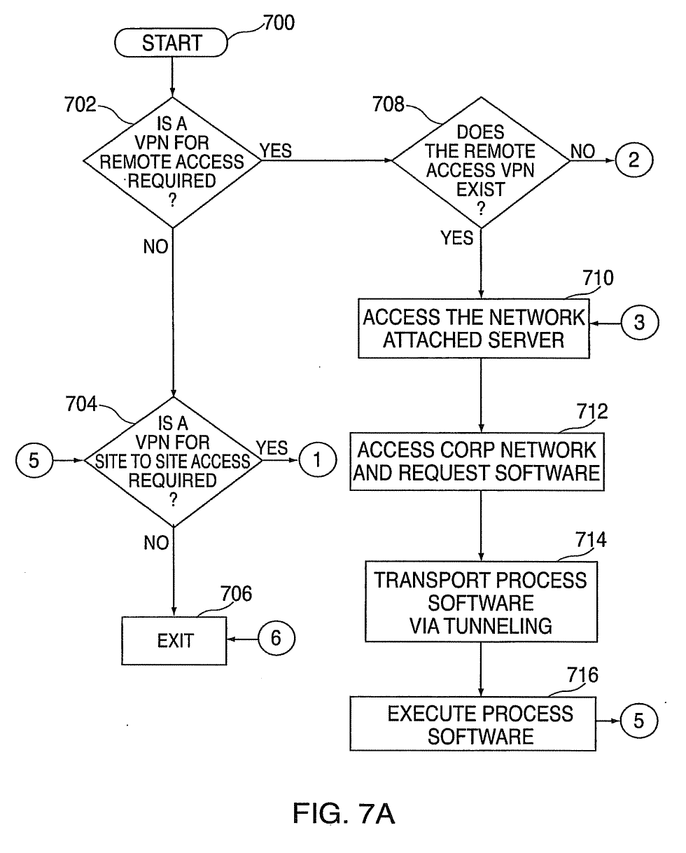

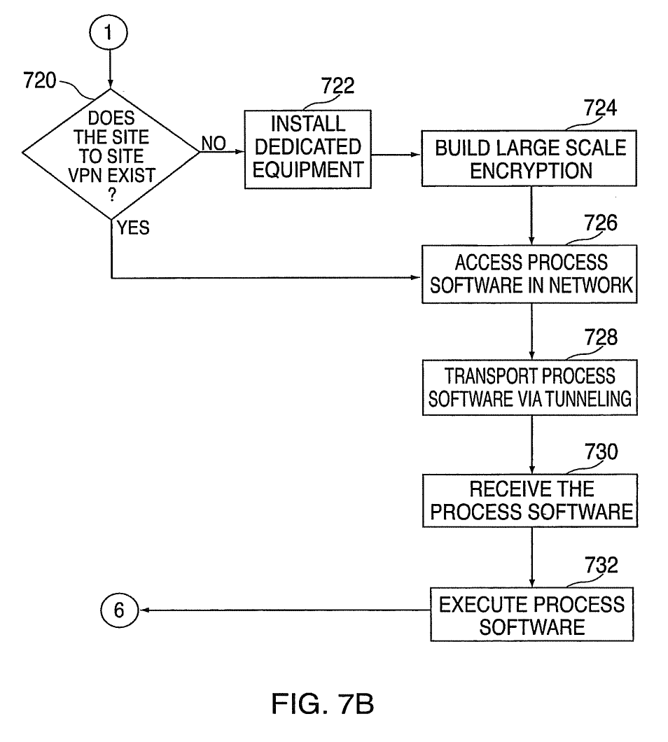

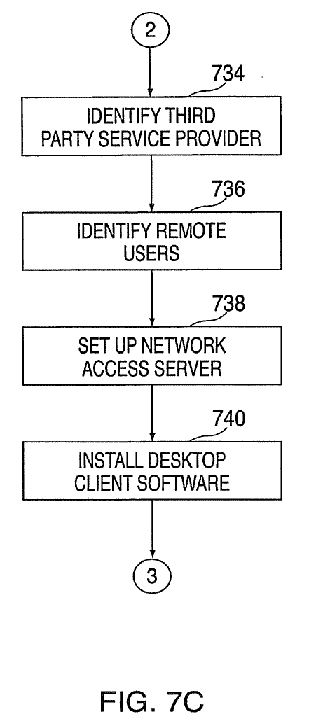

The process software is transported over the VPN via a process called tunneling. Tunneling is process involving the placing of an entire packet within another packet and sending it over a network. The protocol of the outer packet is understood by the network and by both points, called tunnel interfaces, where the packet enters and exits the network. Tunneling generally encapsulates the private network data and protocol information within the public network transmissions so that the private network protocol information appears to the public network simply as unintelligible data. Armed with the foregoing overview of virtual private networks and how they operate and how they may be used to transport the process software, the following more detailed description of same with reference to the flowcharts of FIGS. 7A-7C should be more readily understood.

Step 700 in FIG. 7A begins the virtual private network (VPN) process. A determination is made at step 702 to see if a VPN for remote access is required. If it is not required, then flow proceeds to step 704. If it is required, then flow proceeds to step 708 where a determination is made as to whether a remote access VPN exists that is available for use.

If a remote access VPN does exist, then flow proceeds to step 710 in FIG. 7A. Otherwise flow proceeds to step 734 (see top of FIG. 7C), where a third party provider that will provide the secure, encrypted connections between the company's private network and the company's remote users is identified. Next, as indicated in step 736, the company's remote users are identified. Then, at step 738, the identified third party provider then sets up a network access server (NAS). The NAS allows the remote users to dial a phone number (typically a toll free number) or attach directly via a cable, DSL, wireless or other modem to access, download and install the desktop client software for the remote-access VPN as indicated at step 740.

Returning to step 710 in FIG. 7A, after the remote access VPN has been built or if it been previously installed, the remote users can then access the process software by dialing into the NAS or attaching directly via a cable, DSL, or other modem into the NAS. This step 710 allows entry into the corporate network, as indicated at step 712, where the process software may be accessed. The process software is transported to the remote user's desktop computer over the network via tunneling. During tunneling, see step 714, the process software is divided into packets and each packet, including the data and protocol for that packet, is placed within another packet. When the process software arrives at the remote user's desktop computer, it is removed from the packets, reconstituted, and then may be executed on the remote users desktop, as indicated at step 716.

Returning now to step 704 in FIG. 7A, a determination is made to see if a VPN for site-to-site access is required. If it is not required, then the process exits at step 706. If it is required, flow proceeds to step 720 (see top of FIG. 7B) to determine if the site-to-site VPN exists. If it does exist, then flow proceeds to step 726. If it does not exist, then as indicated at step 722, dedicated equipment required to establish a site-to-site VPN is installed. Then the large-scale encryption is built into the VPN at step 724.

After the site-to-site VPN has been built or if it had been previously established, the users access the process software via the VPN as indicated in step 726. Next, the process software is transported to the site users over the network via tunneling as indicated in step 728. As previously explained, the process software is divided into packets and each packet including the data and protocol is placed within another packet, as indicated in step 730. When the process software arrives at the remote user's desktop, it is removed from the packets, reconstituted, and is executed on the site users desktop at step 732. The process then proceeds to step 706 and exits.

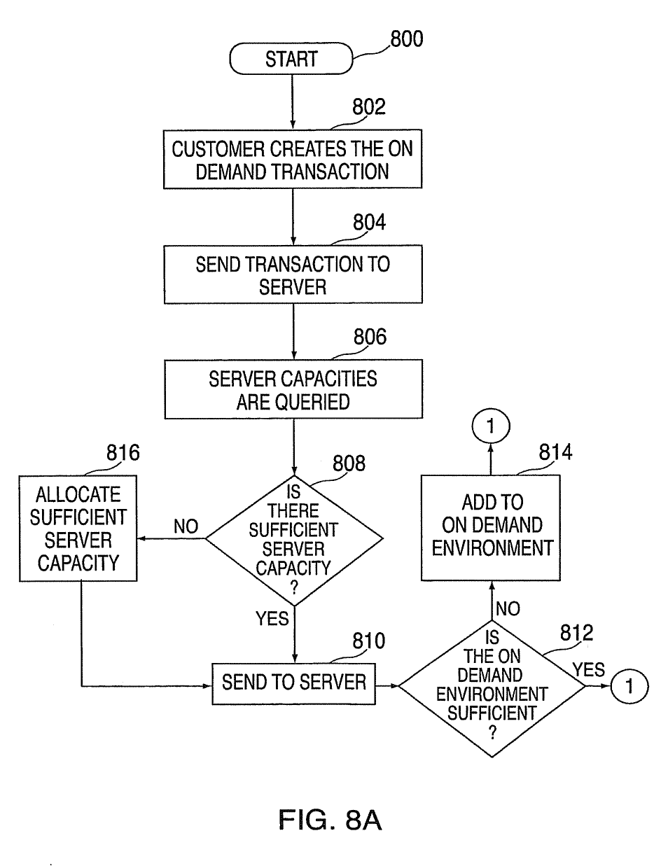

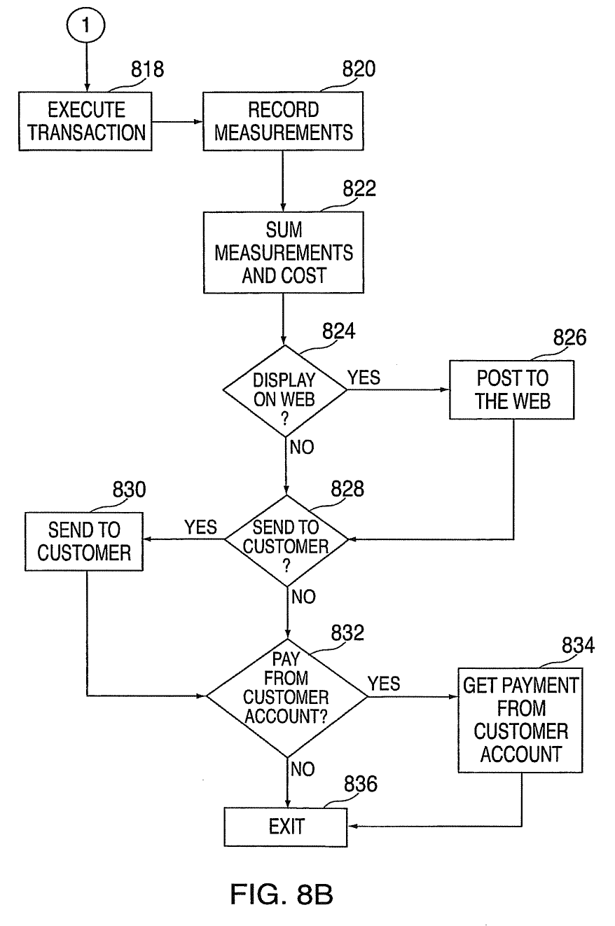

On Demand Computing for Sales Opportunity Modeling System Software. The process software for implementing the sales opportunity modeling system of the present invention may be shared; that is, it may be used to simultaneously serve multiple customers in a flexible, automated fashion. It is process software that is easily standardized, requiring little customization, and it is scalable, thus providing capacity on demand in a pay-as-you-go model known as “on demand” computing. An overview of on demand computing as applied to the sales opportunity modeling system software will now be provided, followed by a more detailed description of same made with reference to the flowcharts of FIGS. 8A and 8B.

The process software for implementing the present invention can be stored on a shared file system accessible from one or more servers. The process software may be executed via transactions that contain data and server processing requests that use measurable CPU units on the accessed server. CPU units are units of time such as minutes, seconds, and hours on the central processor of the server. Additionally, the accessed server may make requests of other servers that require CPU units. CPU units are an example that represents but one measurement of use. Other measurements of use include, but are not limited to, network bandwidth, memory usage, storage usage, packet transfers, complete transactions, etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise, when other measurements of use such as network bandwidth, memory usage, storage usage, etc., approach a capacity so as to affect performance, additional network bandwidth, memory usage, storage etc. are added as needed to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer who then remits payment to the service provider.

In another embodiment, the service provider requests payment directly from a customer account at a banking or financial institution. In yet another embodiment, if the service provider is also a customer of the customer that uses the process software application, the payment owed to the service provider is reconciled to the payment owed by the service provider to minimize the transfer of payments. Armed with the foregoing overview, the detailed description of the on demand computing with respect to the process software, and the following detailed description of same with reference to FIGS. 8A and 8B where the on demand processes are illustrated, will be more easily understood.

Step 800 begins the On Demand process. A transaction is created that contains the unique customer identification, the requested service type and any service parameters that further specify the type of service as indicated in step 802. The transaction is then sent to the main server as shown in step 804. In an On Demand environment, the main server may initially be the only server. Then, as capacity is consumed, other servers are added to the On Demand environment.

The server central processing unit (CPU) capacities in the On Demand environment are queried at step 806. The CPU requirement of the transaction is estimated, then the servers' available CPU capacity in the On Demand environment are compared to the transaction CPU requirement to see if there is sufficient CPU available capacity in any server to process the transaction as indicated in step 808. If there is not sufficient server CPU available capacity, then additional server CPU capacity is allocated to process the transaction as indicated in step 816. If there was already sufficient available CPU capacity, the transaction is sent to a selected server at step 810.

Before executing the transaction, a check is made of the remaining On Demand environment to determine if the environment has sufficient available capacity for processing the transaction as indicated at step 812. This environment capacity consists of elements such as, but not limited to, network bandwidth, processor memory, storage, etc. If there is insufficient available capacity, then capacity will be added to the On Demand environment as indicated in step 814. Next the required software to process the transaction is accessed, loaded into memory, and the transaction is executed as indicated in step 818.

The usage measurements are recorded as indicated in step 820. The usage measurements consist of the portions of those functions in the On Demand environment that are used to process the transaction. The usage of functions such as, but not limited to, network bandwidth, processor memory, storage and CPU cycles are what is recorded. The usage measurements are summed, multiplied by unit costs, and then recorded as a charge to the requesting customer as indicated in step 822.

If the customer has requested that the On Demand costs be posted to a web site as indicated in step 824, then they are posted to a web site at step 826. If the customer has requested that the On Demand costs be sent via e-mail to a customer address as indicated in step 828, then they are sent to the customer via e-mail as indicated in step 830. If the customer has requested that the On Demand costs be paid directly from a customer account at step 832, then payment is received directly from the customer account at step 834. The On Demand process proceeds to step 836 and then exits.

Exemplary embodiments of the present invention provide a variety of useful information regarding purchases at the point of sale or pre-sale period. Product specifications, pricing, taxes, manufacturer warranty registration and rebates, and other data are acquired from various sources such as manufacturing enterprises, selling entities, financial institutions, etc.). Embodiments of the invention acquire, organize, and facilitate dissemination of this information on behalf of individual consumers and/or businesses. Accounting information, warranties, and net worth are some of the information that is managed by the invention. This information may be transferred to designated parties in several manners, including e.g., wireless transfer to a mobile computing device, via email, web access, etc.

As indicated above, the sales opportunity modeling system of the invention includes a sales opportunity evaluation process that provides an enterprise with confidence that there will be a substantial likelihood of success should the opportunity be exploited. The sales opportunity modeling system breaks down the sales opportunity evaluation into multiple stages: detection, verification, and justification. Upon successful completion of the first stage, the evaluation process continues to the second. If at any time, the evaluation process returns undesirable results, the process is either aborted without proceeding to the next stage, or the evaluation criteria is altered and the data is reprocessed. The sales opportunity modeling system further enables an evaluator to review the results at each stage. The result include multi-classification result information including whether the sales opportunity is expected to be successful, unsuccessful (a failure), and if unsuccessful, the reasons therefore.

As described above, the embodiments of the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for implementing a multi-stage, multi-classification sales opportunity modeling system, comprising:
receiving operational data relating to past sales activities;
receiving parameters identified as being relevant in determining a likelihood of whether exploitation of a sales opportunity will be successful; and
generating a multi-stage model by applying the operational data and the parameters to an analytic engine to evaluate different factors affecting success of the sales opportunity.

2. The method of claim 1, wherein the multi-stage model performs:
separating results of an evaluation of the accuracy of information obtained relating to the sales opportunity from results of an evaluation of the worthiness of the sales opportunity.

3. The method of claim 2, wherein the evaluation of
the worthiness of the sales opportunity factors in resource availability, feasibility, and cost effectiveness of the sales opportunity.

4. The method of claim 2, wherein the multi-stage model includes:
a detection stage model for evaluating the accuracy of information obtained relating to the sales opportunity;
a verification stage model for evaluating adequacy of resources and feasibility needed to successfully exploit the sales opportunity; and
a justification stage model for evaluating cost effectiveness of exploiting the sales opportunity.

5. The method of claim 4, further comprising:
applying data relating to the sales opportunity to the detection stage model; and
evaluating a result of executing the detection stage model, the result being at least one of a success, a failure, and a reason for the failure;
wherein, if the result indicates the sales opportunity is unlikely to be successful, performing one of:
aborting the sales opportunity; and
altering the parameters and reapplying the data relating to the sales opportunity to the detection stage model.

6. The method of claim 5, further comprising:
if the result indicates the sales opportunity is likely to be successful, performing:
applying the data relating to the sales opportunity and result of executing the detection stage model to the verification stage model; and
evaluating a result of executing the verification stage model, the result of executing the verification stage model being at least one of a success, a failure, and a reason for the failure;
wherein, if the result of executing the verification stage model indicates the sales opportunity is unlikely to be successful, performing one of:
aborting the sales opportunity; and
altering the parameters and reapplying the data relating to the sales opportunity to the verification stage model.

7. The method of claim 6, further comprising:
if the result of executing the verification stage model indicates the sales opportunity is likely to be successful, performing:
applying the data relating to the sales opportunity and the result of executing the verification stage model to the justification stage model; and
evaluating a result of executing the justification stage model, the result of executing the justification stage model being at least one of a success, a failure, and a reason for the failure;
wherein, if the result of executing the justification stage model indicates the sales opportunity is unlikely to be successful, performing one of:
aborting the sales opportunity; and
altering the parameters and reapplying the data relating to the sales opportunity to the verification stage model.

8. The method of claim 7, wherein if the result of executing the justification stage model indicates that the sales opportunity is likely to be successful, exploiting the sales opportunity.

9. The method of claim 1, further comprising:
extracting data from historical records; and
cleansing extracted data;
wherein the extracting and cleansing results in the operational data, the operational data including:
canceled and fulfilled orders;
receipts;
invoices; and
shipping data.

10. The method of claim 1, further comprising
deploying process software for implementing said multi-stage, multi-classification sales opportunity modeling system, said deploying comprising:
installing said process software on at least one server;
identifying server addresses for users accessing said process software on said at least one server;
installing a proxy server if needed;
sending said process software to said at least one server and copying said process software to a file system of said at least one server;
sending the process software to at least a first client computer; and
executing said process software on said first client computer.

11. The method of claim 1, further comprising integrating process software for implementing said multi-stage, multi-classification sales opportunity modeling system, said integrating comprising:
determining if said process software will execute on at least one server;
identifying an address of said at least one server;
checking said at least one server for operating systems, applications, and version numbers for validation with said process software, and identifying any missing software applications for said at least one server that are required for integration;
updating said at least one server with respect to any operating system and application that is not validated for said process software, and providing any of said missing software applications for said at least one server required for said integration;
identifying client addresses and checking client computers for operating systems, applications, and version numbers for validation with said process software, and identifying any software applications missing from said client computers that are required for integration;
updating said client computers with respect to any operating system and application that is not validated for said process software, and providing any missing software application for said client computers required for said integration; and
installing said process software on said client computers and said at least one server.

12. The method of claim 1, further comprising on-demand sharing of process software for implementing said multi-stage, multi-classification sales opportunity modeling system, said on demand sharing comprising:
creating a transaction containing unique customer identification, requested service type, and service parameters;
sending said transaction to at least one main server;
querying said at least one main server about processing capacity associated with said at least one main server to help ensure availability of adequate resources for processing of said transaction; and
allocating additional processing capacity when additional capacity appears needed to process said transaction, said additional processing capacity being selected from the group of additional capacities consisting of central processing unit capacity, processor memory capacity, network bandwidth capacity, and storage capacity.

13. The method of claim 1, further comprising deploying, accessing, and executing process software for implementing said multi-stage, multi-classification sales opportunity modeling system, said deploying, accessing, and executing process software implemented through a virtual private network, the method further comprising:
determining if a virtual private network is required;
checking for remote access to said virtual private network when it is required;
if said remote access does not exist, identifying a third party provider to provide secure, encrypted connections between a private network and remote users;
identifying said remote users; and
setting up a network access server operable for downloading and installing client software on desktop computers for remote access of said virtual private network;
accessing said process software;
transporting said process software to at least one remote user's desktop computer; and
executing said process software on said at least one remote user's desktop computer.

14. A system for implementing a multi-stage, multi-classification sales opportunity modeling system, comprising:
a processor executing a sales opportunity modeling application; and
a storage device housing operational data relating to past sales activities;
wherein the sales opportunity modeling application performs:
receiving parameters identified as being relevant in determining a likelihood of whether exploitation of a sales opportunity will be successful; and
generating a multi-stage model by applying the operational data and the parameters to an analytic engine.

15. The system of claim 14, wherein the multi-stage model includes:
a detection stage model for evaluating accuracy of information obtained relating to the sales opportunity;
a verification stage model for evaluating adequacy of resources and feasibility needed to successfully exploit the sales opportunity; and
a justification stage model for evaluating cost effectiveness of exploiting the sales opportunity.

16. The system of claim 15, wherein the sales opportunity modeling application further performs:
applying data relating to the sales opportunity to the detection stage model; and
evaluating a result of executing the detection stage model, the result being at least one of a success, a failure, and a reason for the failure;
wherein, if the result indicates the sales opportunity is unlikely to be successful, performing one of:
aborting the sales opportunity; and
altering the parameters and reapplying the data relating to the sales opportunity to the detection stage model.

17. The system of claim 16, wherein the sales opportunity modeling application further performs:
if the result indicates the sales opportunity is likely to be successful, performing:
applying the data relating to the sales opportunity and result of executing the detection stage model to the verification stage model; and
evaluating a result of executing the verification stage model, the result of executing the verification stage model being at least one of a success, a failure, and a reason for the failure;
wherein, if the result of executing the verification stage model indicates the sales opportunity is unlikely to be successful, performing one of:
aborting the sales opportunity; and
altering the parameters and reapplying the data relating to the sales opportunity to the verification stage model.

18. The system of claim 17, wherein the sales opportunity modeling application further performs:
if the result of executing the verification stage model indicates the sales opportunity is likely to be successful, performing:
applying the data relating to the sales opportunity and the result of executing the verification stage model to the justification stage model; and
evaluating a result of executing the justification stage model, the result of executing the justification stage model being at least one of a success, a failure, and a reason for the failure;
wherein, if the result of executing the justification stage model indicates the sales opportunity is unlikely to be successful, performing one of:
aborting the sales opportunity; and
altering the parameters and reapplying the data relating to the sales opportunity to the verification stage model.

19. The system of claim 18, wherein if the result of executing the justification stage model indicates that the sales opportunity is likely to be successful, exploiting the sales opportunity.

20. The system of claim 14, wherein the sales opportunity modeling application further performs:
extracting data from historical records; and
cleansing extracted data;
wherein the extracting and cleansing results in the operational data, the operational data including:
canceled and fulfilled orders;
receipts;
invoices; and
shipping data.

21. A storage medium encoded with machine-readable program code for implementing a multi-stage, multi-classification sales opportunity modeling system, the program code including instructions for causing a processor to implement a method comprising:
receiving operational data relating to past sales activities;
receiving parameters identified as being relevant in determining a likelihood of whether exploitation of a sales opportunity will be successful; and
generating a multi-stage model by applying the operational data and the parameters to an analytic engine to evaluate different factors affecting success of the sales opportunity.

22. The storage medium of claim 21, wherein the multi-stage model performs:
separating results of an evaluation of the accuracy of information obtained relating to the sales opportunity from results of an evaluation of the worthiness of the sales opportunity.

23. The storage medium of claim 22, wherein the evaluation of the worthiness of the sales opportunity factors in resource availability, feasibility, and cost effectiveness of the sales opportunity.

24. The storage medium of claim 22, wherein the multi-stage model includes:
a detection stage model for evaluating the accuracy of information obtained relating to the sales opportunity;
a verification stage model for evaluating adequacy of resources and feasibility needed to successfully exploit the sales opportunity; and
a justification stage model for evaluating cost effectiveness of exploiting the sales opportunity.

25. The storage medium of claim 24, further comprising instructions for causing the processor to implement:
applying data relating to the sales opportunity to the detection stage model; and
evaluating a result of executing the detection stage model, the result being at least one of a success, a failure, and a reason for the failure;
wherein, if the result indicates the sales opportunity is unlikely to be successful, performing one of:
aborting the sales opportunity; and
altering the parameters and reapplying the data relating to the sales opportunity to the detection stage model.

26. The storage medium of claim 25, further comprising instructions for causing the processor to implement:
if the result indicates the sales opportunity is likely to be successful, performing:
applying the data relating to the sales opportunity and result of executing the detection stage model to the verification stage model; and
evaluating a result of executing the verification stage model, the result of executing the verification stage model being at least one of a success, a failure, and a reason for the failure;
wherein, if the result of executing the verification stage model indicates the sales opportunity is unlikely to be successful, performing one of:
aborting the sales opportunity; and
altering the parameters and reapplying the data relating to the sales opportunity to the verification stage model.

27. The storage medium of claim 26, further comprising instructions for causing the processor to implement:
if the result of executing the verification stage model indicates the sales opportunity is likely to be successful, performing:
applying the data relating to the sales opportunity and the result of executing the verification stage model to the justification stage model; and
evaluating a result of executing the justification stage model, the result of executing the justification stage model being at least one of a success, a failure, and a reason for the failure;
wherein, if the result of executing the justification stage model indicates the sales opportunity is unlikely to be successful, performing one of:
aborting the sales opportunity; and
altering the parameters and reapplying the data relating to the sales opportunity to the verification stage model.

28. The storage medium of claim 27, wherein if the result of executing the justification stage model indicates that the sales opportunity is likely to be successful, exploiting the sales opportunity.

29. The storage medium of claim 21, further comprising instructions for causing the processor to implement:
extracting data from historical records; and
cleansing extracted data;
wherein the extracting and cleansing results in the operational data, the operational data including:
canceled and fulfilled orders;
receipts;
invoices; and
shipping data.
